(19) United States
(12) Patent Application Publication
(10) Pub. No.: US 2026/0210379 A1
(43) Pub. Date: Jul. 23, 2026

(54) DUAL-PROFILE STRONG-SUCTION VORTEX FAN BLADE, FAN AND ELECTRONIC DEVICE

(71) Applicant: NANCHANG HUAQIN ELECTRONIC TECHNOLOGY CO., LTD, Jiangxi (CN)

(72) Inventors: CHUANSHENG LI, Jiangxi (CN); BINJUN YU, Jiangxi (CN); CHUNXIANG FANG, Jiangxi (CN)

(21) Appl. No.: 19/142,340

(22) PCT Filed: Aug. 21, 2024
(86) PCT No.: PCT/CN2024/113551

§ 371 Date: Jun. 23, 2025

(30) Foreign Application Priority Data
Aug. 23, 2023 (CN) 202311065594.X

(51) Int. Cl. F04D 29/66; F04D 17/02; F04D 29/38

(52) U.S. Cl. CPC F04D 29/666; F04D 17/025; F04D 29/384

(57) ABSTRACT

A dual-profile strong-suction vortex fan blade includes a base, and centrifugal blades and axial flow blades respectively connected to the base. The centrifugal blades and the axial flow blades circumferentially surround an outer periphery of the base, respectively, and the axial flow blades are arranged at an air intake side of the centrifugal blades. A gap is formed between every two adjacent centrifugal blades. The number of centrifugal blades is 2N times the number of axial flow blades so that the number of gaps is also 2N times the number of axial flow blades. Each axial flow blade extends obliquely relative to an axial direction and gradually approaches two adjacent gaps which are right opposite to the axial flow blade, so that each axial flow blade guides external gas into the two corresponding gaps in order.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/CN2024/113551 filed on Aug. 21, 2024, which claims priority to the benefit of Chinese Patent Application No. 202311065594.X filed on Aug. 23, 2023 in the China Intellectual Property Office, the entire contents of which are incorporated herein by reference.

### BACKGROUND

### 1. Technical Field

The present disclosure relates to the technical field of fans, and particularly relates to a dual-profile strong-suction vortex fan blade, a fan and an electronic device.

### 2. Background of the Invention

Most of the existing fans are axial flow fans or centrifugal fans. The axial flow fan may be interpreted as a fan in which incoming and outcoming air are both along an axial direction of the fan, such as domestic ceiling fans or small desk fans, and the like, while the centrifugal fan, also referred to as a radial fan, may be interpreted as a fan in which incoming air is along an axial direction of the fan while outcoming air is along a radial direction of the fan. Currently, with the increased performance of laptops, more lightweight fans with higher heat dissipation performance are preferred. Therefore, most of the laptops adopt centrifugal fans therein for rapid heat dissipation from the inside of the laptops to the outside.

Specifically, the conventional centrifugal fans have backflow, which may be interpreted as a phenomenon caused by air pushed radially by centrifugal blades and unable to be discharged outward, where when blown radially, a small part of the air will overflow in an opposite direction to the axial air incoming direction and collide with the incoming air in the axial direction, and even forms a vortex in the fan, so that a certain impedance is formed during rotation of the centrifugal blades, which further influence the air volume to some extent.

More specifically, a combined fan including axial flow blades and centrifugal blades has been adopted, where the axial flow blades can guide air to the centrifugal blades to properly inhibit overflow of the air pushed by the centrifugal blades in the axial direction, i.e., to reduce the generation of backflow, improve the impedance overcoming capability of the fan, and further increase the air volume of the fan. However, in the existing art, the axial flow blades and the centrifugal blades are simply spliced together, which has a limited effect on reducing backflow. In other words, the impedance overcoming capability during rotation of the centrifugal blades is still weak, resulting in more energy loss of the fan and a still low air volume. With the improved performance of laptops and the higher requirement on heat dissipation, the laptops are desired to be equipped with fans of stronger impedance overcoming capability and higher air volume. Therefore, how to significantly reduce backflow and improve the impedance overcoming capability as well as the air volume of the fan remains a challenging technical problem in the field of fans.

### SUMMARY

One object of the present disclosure is to provide a dual-profile strong-suction vortex fan blade, a fan and an electronic device which mainly solve the technical problem of low air volume of existing centrifugal fans due to the weak impedance overcoming capability.

To achieve this object, the present disclosure adopts the following technical solutions:

A dual-profile strong-suction vortex fan blade is provided, including a base, and a plurality of centrifugal blades and a plurality of axial flow blades respectively connected to the base, where the plurality of centrifugal blades and the plurality of axial flow blades circumferentially surround an outer periphery of the base, respectively, and the plurality of axial flow blades are arranged at an air intake side of the plurality of centrifugal blades; a gap is formed between every two adjacent centrifugal blades; the number of centrifugal blades is 2N times the number of axial flow blades, so that the number of gaps is also 2N times the number of axial flow blades; and each axial flow blade extends obliquely relative to an axial direction and gradually approaches two adjacent gaps which are right opposite to the axial flow blade, so that each axial flow blade guides external gas into the two corresponding gaps in order, where N is a positive integer.

In one technical solution, a surface of the axial flow blades facing the centrifugal blades is a first air guide surface; a surface of the axial flow blades facing away from the centrifugal blades is a second air guide surface; the first air guide surface and the second air guide surface of each axial flow blade both gradually approach the gap obliquely; and the first air guide surface and the second air guide surface of each axial flow blade have projections in the axial direction falling into the same two adjacent gaps, so that the first air guide surface of one axial flow blade and the second air guide surface of another adjacent axial flow blade cooperate to guide external gas into the two corresponding gaps.

In one technical solution, the first air guide surface and the second air guide surface are both curved structures recessed toward the centrifugal blades.

In one technical solution, each centrifugal blade includes a guide part and a blowing part; the guide part and the blowing part are sequentially connected in a direction gradually away from the base, the guide part is convex in a rotating direction of the centrifugal blade, and the blowing part is convex in an opposite direction to the rotating direction of the centrifugal blade; and ends of the first air guide surface and the second air guide surface away from the base both extend to a position adjacent to a joint of the guide part and the blowing part.

In one technical solution, a surface of the guide part directly facing the axial flow blades is a first side surface, the first air guide surface extends obliquely to a position adjacent to the first side surface of a first centrifugal blade, and the end of the first air guide surface away from the base extends to a position adjacent to a joint of the guide part and the blowing part of a second centrifugal blade; wherein the first centrifugal blade and the second centrifugal blade are two adjacent centrifugal blades sequentially arranged in a rotating direction of the fan blades.

In one technical solution, the first side surface has a curved surface structure recessed in the axial direction, so that inner rings of all blowing parts form a circle of accommodation space in which the axial flow blades are received.

In one technical solution, the dual-profile strong-suction vortex fan blade further includes an outer ring connecting blowing parts of all the centrifugal blades.

The present application further provides a fan adopting the dual-profile strong-suction vortex fan blade according to any one of the above technical solutions.

The present application further provides an electronic device, including the fan according to the above technical solution.

Compared with the existing art, the dual-profile strong-suction vortex fan blade of the present disclosure has at least the following beneficial effects:

This solution also adopts a combined structure of centrifugal blades and axial flow blades, where the axial flow blades not only improve an axial air suction capacity, but also inhibit the overflow of air pushed by the centrifugal blades in an opposite direction to an air incoming direction; in this solution, specifically, the number of axial flow blades is set to be half of the number of centrifugal blades, and each axial flow blade is designed to gradually approach two corresponding adjacent gaps obliquely, so that each axial flow blade can orderly guide external gas into the two corresponding gaps, that is, the axial air suction capacity is significantly improved, and overflow of the air pushed by the centrifugal blades in the opposite direction is significantly inhibited, thereby significantly reducing the generation of backflow, and improving the impedance overcoming capability as well as the air volume of the fan. Especially in the case of a great number of centrifugal blades (for example, when fan blades are used in an interior space of a laptop), the air volume can be increased by a more significant proportion.

### BRIEF DESCRIPTION OF THE DRAWINGS

To illustrate the technical solutions in the embodiments of the present disclosure or the existing art more clearly, the drawings to be used in description of the embodiments or the existing art will be briefly described below. Apparently, the drawings in the following description are merely some embodiments of the present disclosure, and other drawings may be derived from these drawings by those of ordinary skill in the art without any creative labor.

FIG. 1 is a schematic structural diagram of a dual-profile strong-suction vortex fan blade according to an embodiment of the present disclosure;

FIG. 2 is a front view of a dual-profile strong-suction vortex fan blade according to an embodiment of the present disclosure;

FIG. 3 is an enlarged partial view of FIG. 2 at A;

FIG. 4 is a rear view of a dual-profile strong-suction vortex fan blade according to an embodiment of the present disclosure;

FIG. 5 is an enlarged partial view of FIG. 4 at B;

FIG. 6 is a schematic structural diagram of a dual-profile strong-suction vortex fan blade according to an embodiment of the present disclosure from another perspective;

FIG. 7 is an enlarged partial view of FIG. 6 at C;

FIG. 8 is a schematic diagram illustrating air volume values at various positions in a flow field distribution of a conventional fan blade at a rotating speed of 5400 rpm;

FIG. 9 is a schematic diagram illustrating static pressure forces at various positions in a flow field distribution of a conventional fan blade at a rotating speed of 5400 rpm;

FIG. 10 is a schematic diagram illustrating air volume values at various positions in a flow field distribution of a dual-profile strong-suction vortex fan blade according to an embodiment of the present disclosure at a rotating speed of 5400 rpm; and

FIG. 11 is a schematic diagram illustrating static pressure forces at various positions in a flow field distribution of a dual-profile strong-suction vortex fan blade according to an embodiment of the present disclosure at a rotating speed of 5400 rpm.

### DETAIL DESCRIPTION

To make the technical problem to be solved, technical solutions and advantageous effects of the present application clearer and more apparent, the present application is further described in detail below with reference to the accompanying drawings and embodiments. It will be appreciated that the specific embodiments described herein are merely for illustration of the present application and are not intended to limit the present application.

It should be noted that when an element is referred to as being “secured to” or “disposed on” another element, it may be directly or indirectly provided on the other element. When an element is referred to as being “connected to” another element, it may be directly or indirectly connected to the other element.

It is to be understood that the terms “upper”, “lower”, “top”, “bottom”, “inner”, “outer”, and the like are based on the orientations or positional relationships shown in the drawings, and are merely for the purposes of describing the present application and simplifying the description, instead of indicting or implying that the device or component referred to must have a specific orientation or be configured or operated at a specific orientation, and thus should not be interpreted as limitations to the present application.

Furthermore, the terms “first”, “second”, and the like are used for descriptive purposes only and are not to be construed as indicating or implying relative importance or to implicitly indicate a number of the indicated technical features. Therefore, a feature defined by “first” or “second” may include one or more of the indicated features either explicitly or implicitly. In the description of the present application, “a plurality of” means two or more unless explicitly defined otherwise.

To make the objects, technical solutions and advantages of the present disclosure clearer and more apparent, the present disclosure is further described in detail below with reference to the accompanying drawings and embodiments.

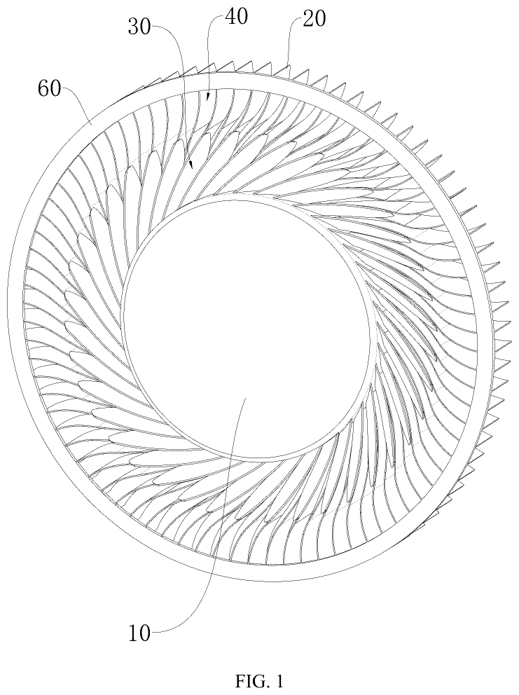

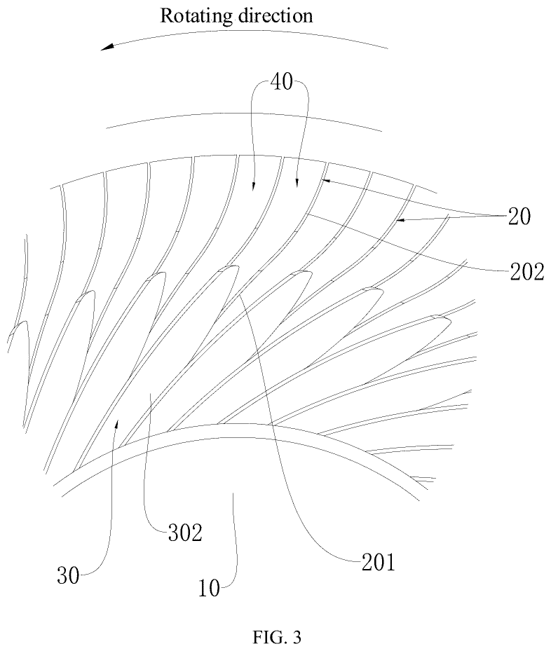

Referring to FIGS. 1 to 3 together, an embodiment provides a dual-profile strong-suction vortex fan blade, including a base 10, a plurality of centrifugal blades 20, and a plurality of axial flow blades 30, which are connected with each other. The plurality of centrifugal blades 20 circumferentially surround an outer periphery of the base 10. A gap 40 is formed between every two adjacent centrifugal blades 20. The centrifugal blades 20 extend in an axial direction to a greater depth, so that the centrifugal blades 20 can push air in the gap 40 to be blown out in a radial direction. The plurality of axial flow blades 30 also circumferentially surround an outer periphery of the base 10. The axial flow blades 30 are arranged on air intake sides of the centrifugal blades 20, and extend obliquely relative to the axial direction. When the axial flow blades 30 and the centrifugal blades 20 are rotated together, the axial flow blades 30 are configured to improve the axial air suction capability of the fan blades. In other words, the axial flow blades 30 can prevent the air radially blown out by the centrifugal blades 20 from reversely overflowing out of the gap 40 along the air intake side, thereby reducing the generation of backflow, improving the impedance overcoming capability of the fan blades, and finally increasing the air volume of the fan blades.

The reference to “extend in an axial direction” may refer to extending outward from a central axis.

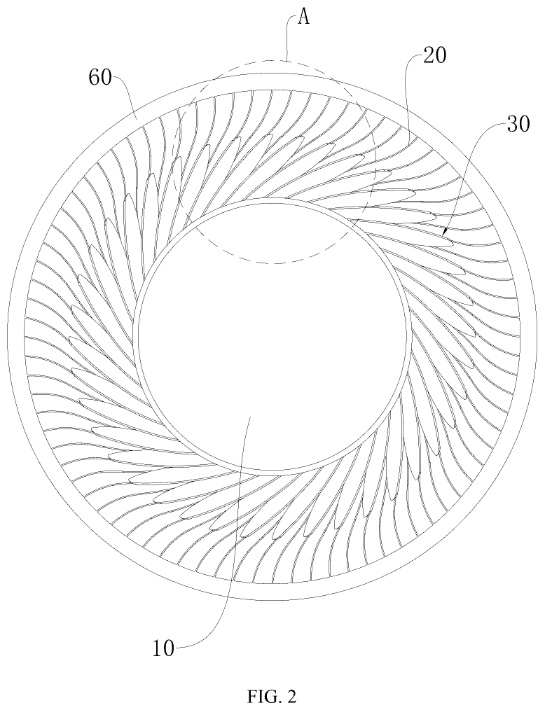

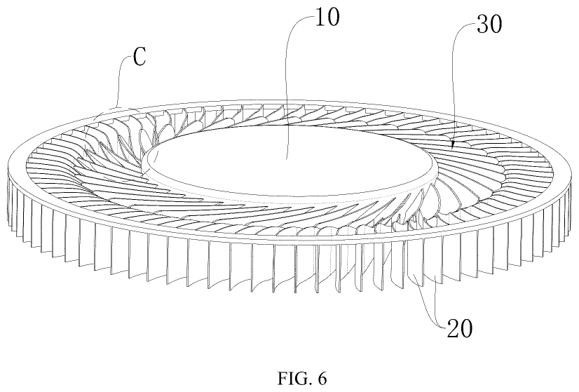

Specifically, referring to FIGS. 2, 3, 6 and 7 together, in this embodiment, the number of centrifugal blades 20 is 2N times the number of axial flow blades 30, so that the number of gaps 40 is also 2N times the number of axial flow blades 30, where N is a positive integer. Moreover, when each axial flow blade 30 extends obliquely relative to the axial direction, it gradually approaches two adjacent gaps 40 which are right opposite to the axial flow blade, so that each axial flow blade 30 can guide external gas into the two corresponding gaps 40 in order. By guiding external gas into the two corresponding gaps 40 in order, the axial air suction capability of the fan blades can be further improved, that is, further prevent the air radially blown out by the centrifugal blades 20 from reversely overflowing out of the gap 40 along the air intake side, thereby further reducing the generation of backflow, further improving the impedance overcoming capability of the fan blades, and finally increasing the air volume of the fan blades.

The axial flow blade 30 gradually approaches two adjacent gaps 40 which are right opposite to the axial flow blade when extending obliquely relative to the axial direction may be interpreted as that a plane with the oblique axial extension gets closer and closer to a plane where the corresponding centrifugal blade is located.

For example, N is 1, which means that the number of centrifugal blades 20 is twice the number of axial flow blades 30. N is 2, which means that the number of centrifugal blades 20 is 4 times the number of axial flow blades 30. N may be any other positive integer, and for convenience of description, the following embodiments take N equal to 1 as an example for illustration, which is not limited in the present application.

Specifically, referring to FIGS. 2, 3, 6 and 7 together, in this embodiment, the number of centrifugal blades 20 is twice the number of axial flow blades 30, so that the number of gaps 40 is also twice the number of axial flow blades 30. Moreover, when each axial flow blade 30 extends obliquely relative to the axial direction, it gradually approaches two adjacent gaps 40 which are right opposite to the axial flow blade, so that each axial flow blade 30 can guide external gas into the two corresponding gaps 40 in order. By guiding external gas into the two corresponding gaps 40 in order, the axial air suction capability of the fan blades can be further improved, that is, further prevent the air radially blown out by the centrifugal blades 20 from reversely overflowing out of the gap 40 along the air intake side, thereby further reducing the generation of backflow, further improving the impedance overcoming capability of the fan blades, and finally increasing the air volume of the fan blades.

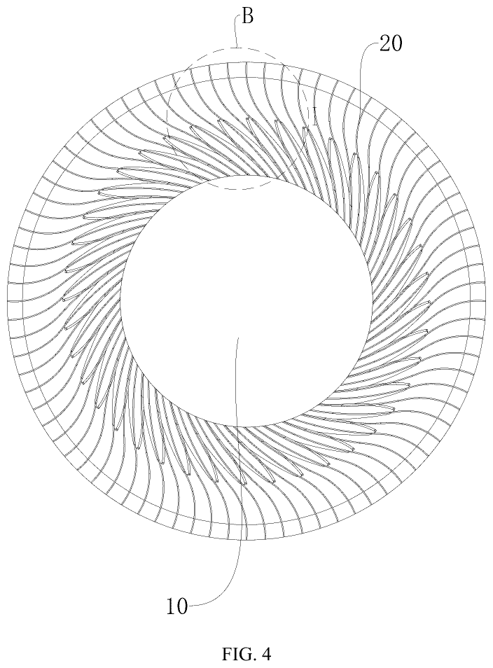

More specifically, referring to FIGS. 2 to 7 together, a surface of the axial flow blades 30 facing the centrifugal blades 20 is a first air guide surface 301; a surface of the axial flow blades 30 facing away from the centrifugal blades 20 is a second air guide surface 302; the first air guide surface 301 and the second air guide surface 302 of each axial flow blade 30 both gradually approach the gap 40 obliquely relative to the axial direction; and the first air guide surface 301 and the second air guide surface 302 have projections in the axial direction falling into the same two adjacent gaps 40, so that the first air guide surface 301 of one axial flow blade 30 and the second air guide surface 302 of another adjacent axial flow blade 30 can cooperate to guide external gas into the two corresponding gaps 40 in order.

It should be supplemented here that it is a specific choice to design the number of centrifugal blades 20 to be twice the number of axial flow blades 30. When the axial flow blades 30 are provided in one-to-one correspondence with the centrifugal blades 20, the axial flow blades 30 are more inclined to be parallel to the axial direction when extending obliquely. In this case, the axial air suction performance of the axial flow blades 30 is reduced, and the shape of each axial flow blade 30 tends to be smaller due to the large number of axial flow blades 30, which increases the forming difficulty of the axial flow blade 30. When the number of centrifugal blades 20 is designed to be three times or more of the number of axial flow blades 30, the number of axial flow blades 30 will be reduced. With the reduced number of axial flow blades 30, the axial air suction performance is also reduced, and it is more difficult to inhibit the overflow of the air in the gap 40 toward the air intake side, that is, more backflow will occur.

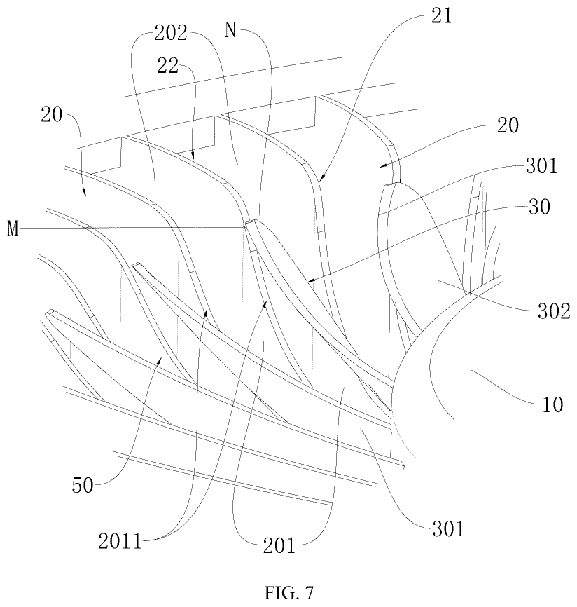

Referring to FIG. 7, the first air guide surface 301 and the second air guide surface 302 are both curved structures recessed toward the centrifugal blades 20, in which the axial flow blade 30 is also referred to as a dragonfly wing blade having a shape like a dragonfly wing, and has better air suction performance.

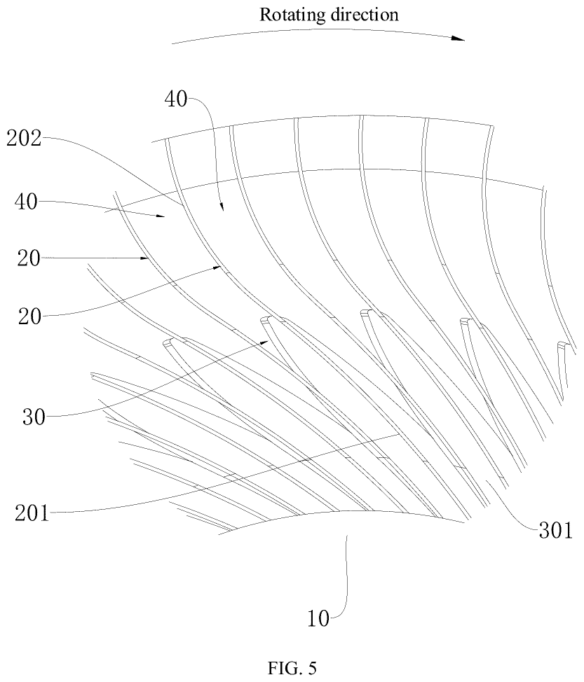

Referring to FIGS. 5 and 7 together, each centrifugal blade 20 includes a guide part 201 and a blowing part 202. The guide part 201 and the blowing part 202 are sequentially connected in a direction gradually away from the base 10. The guide part 201 is convex in a rotating direction of the centrifugal blade 20, while the blowing part 202 is convex in an opposite direction to the rotating direction of the centrifugal blade 20. The blowing part 202 is a main part that applies work to gas. In this configuration, the centrifugal blade 20 has better blowing performance and can properly inhibit the generation of backflow, thereby increasing the air volume of the fan. Further, ends of the first air guide surface 301 and the second air guide surface 302 away from the base 10 (i.e., the positions indicated by M and N in FIG. 7) both extend to a position adjacent to a joint of the guide part 201 and the blowing part 202, so that two adjacent axial flow blades 30 can cooperate to guide external gas rapidly into the blowing part 202 along the guide part 201, and the air in the guide part 201 is prevented from overflowing in an opposite direction along the air intake side, thereby still further reducing the generation of backflow, still further improving the impedance overcoming capability of the fan blades, and finally increasing the air volume of the fan blades.

Referring again to FIG. 7, a surface of the guide part 201 directly facing the axial flow blades 30 is a first side surface 2011. The first air guide surface 301 extends obliquely relative to the axial direction to a position adjacent to the first side surface 2011 of a first centrifugal blade 21. An end of the first air guide surface 301 away from the base 10 (i.e., M in FIG. 7) extends to a position adjacent to a joint of the guide part 201 and the blowing part 202 of a second centrifugal blade 22. The first centrifugal blade 21 and the second centrifugal blade 22 are two adjacent centrifugal blades 20 sequentially arranged in a rotating direction of the fan blades. With such a design, a gap between the first side surface 2011 and the first air guide surface 301 is reduced while improving the air suction capability of the axial flow blade 30, so that gas overflowing outward through the gap between the first side surface 2011 and the first air guide surface 301 in the process of entering the gap 40 is reduced as much as possible, thereby further reducing the generation of backflow, further improving the impedance overcoming capability of the fan blades, and finally further increasing the air volume of the fan blades.

In addition, referring again to FIG. 7, the first side surface 2011 has a curved surface structure recessed in the axial direction. In other words, inner rings of all blowing parts 202 form a circle of accommodation space 50, in which the axial flow blades 30 are accommodated and distributed at intervals in a circumferential direction, so that the thickness of the blades is reduced and the blades are applicable to the interior space of an existing thin laptop.

Referring to FIG. 1, in this embodiment, the dual-profile strong-suction vortex fan blade further includes an outer ring 60 connecting blowing parts 202 of all the centrifugal blades 20, so as to improve the rigidity and strength of the blowing parts 202 and prevent the blowing parts 202 from being greatly deformed under a reaction force of gas.

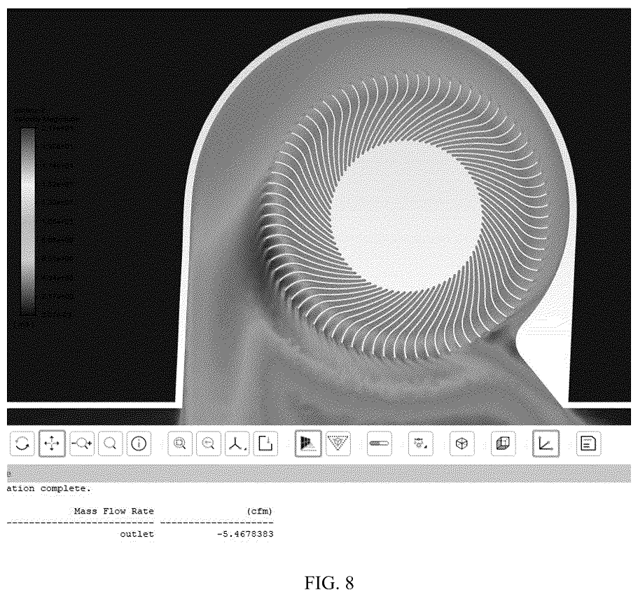

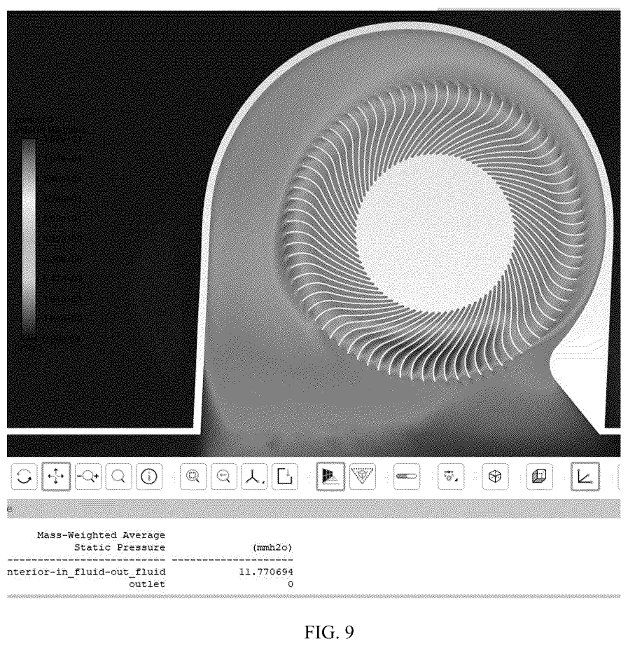

Referring to FIGS. 8 to 11, FIG. 8 is a schematic diagram illustrating air volume values at various positions in a flow field distribution of a conventional fan blade (with only centrifugal blades 20) at a rotating speed of 5400 rpm; FIG. 9 is a schematic diagram illustrating static pressure forces at various positions in a flow field distribution of a conventional fan blade (with only centrifugal blades 20) at a rotating speed of 5400 rpm;

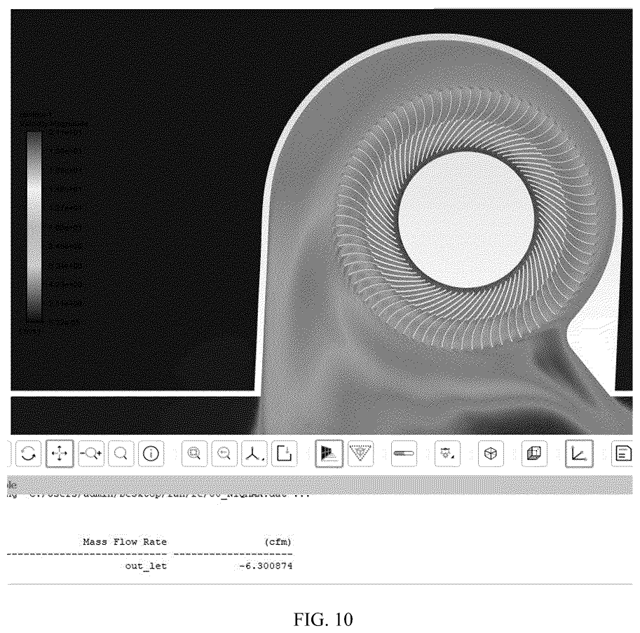

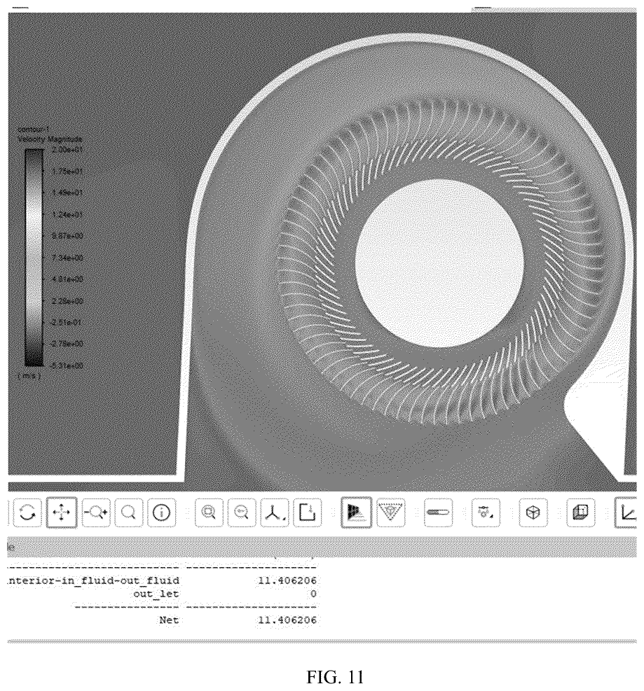

FIG. 10 is a schematic diagram illustrating air volume values at various positions in a flow field distribution of a dual-profile strong-suction vortex fan blade according to an embodiment of the present disclosure at a rotating speed of 5400 rpm; and FIG. 11 is a schematic diagram illustrating static pressure forces at various positions in a flow field distribution of a dual-profile strong-suction vortex fan blade according to an embodiment of the present disclosure at a rotating speed of 5400 rpm. The experimental data of FIGS. 8 to 11 are summarized below:

| | Rotating speed | Air volume | Static pressure |
|---|---|---|---|
| | (rpm) | (cfm) | (mmh 20) |
| Conventional fan blade | 5400 | 5.47 | 11.77 |
| Dual-profile fan blade | | 6.3 | 11.41 |

As can be seen from the data in the above table, under a given rotating speed, the maximum static pressure of the dual-profile fan blade of the embodiment is substantially the same as the conventional fan blade, while the maximum air volume is increased by about 15%.

In summary, in the embodiment of the present disclosure, each axial flow blade 30 can orderly guide external gas into the two corresponding gaps 40, so that the axial air suction capacity is significantly improved, and overflow of the air in the gap 40 in the opposite direction is significantly inhibited, thereby significantly reducing the generation of backflow, and improving the impedance overcoming capability as well as the air volume of the fan. Especially in the case of a great number of centrifugal blades 20, the axial flow blades 30 as dragonfly wing blades are arranged more densely, so that air suction is smoother, and the air volume can be increased by a more significant proportion, which are very suitable for fan blades of a cooling fan inside a laptop.

An embodiment further provides a fan, including a motor and the dual-profile strong-suction vortex fan blade as described above. An output shaft of the motor is connected to the dual-profile strong-suction vortex fan blade, and the motor is configured to drive the dual-profile strong-suction vortex fan blade to rotate. With the dual-profile strong-suction vortex fan blade, the fan can greatly increase the value of air volume while the static pressure remains almost unchanged, thereby meeting the heat dissipation requirements of a lightweight and high-performance laptop.

An embodiment further provides an electronic device, including the fan as described above. For example, the electronic device is a laptop, and the fan is disposed inside the laptop and configured for heat dissipation of circuit modules in the laptop. By means of the fan with excellent heat dissipation performance, the electronic device of the embodiment can allow further enhanced performance.

The foregoing are merely preferred embodiments of the present disclosure, and merely specifically describe the technical principles of the present disclosure. These descriptions are intended only to explain the principles of the present disclosure, and shall not in any way be interpreted as limiting the scope of protection of the present disclosure. Based on such explanation, any amendments, equivalent substitutions and improvements within the spirit and principle of the present disclosure, and other specific implementations of the present disclosure that can be conceived by those skilled in the art without any creative labor, are all included in the scope of the protection of the present disclosure.

1: A dual-profile strong-suction vortex fan blade, comprising:
a base; and
a plurality of centrifugal blades and a plurality of axial flow blades respectively connected to the base,
wherein the plurality of centrifugal blades and the plurality of axial flow blades circumferentially surround an outer periphery of the base, respectively, and the plurality of axial flow blades are arranged at an air intake side of the plurality of centrifugal blades; a gap is formed between every two adjacent centrifugal blades; the number of centrifugal blades is twice the number of axial flow blades, so that the number of gaps is also twice the number of axial flow blades; and each axial flow blade extends obliquely relative to an axial direction and gradually approaches two adjacent gaps which are right opposite to the axial flow blade, so that each axial flow blade guides external gas into the two corresponding gaps in order.

2: The dual-profile strong-suction vortex fan blade of claim 1, wherein a surface of the axial flow blades facing the centrifugal blades is a first air guide surface; a surface of the axial flow blades facing away from the centrifugal blades is a second air guide surface; the first air guide surface and the second air guide surface of each axial flow blade both gradually approach the gap obliquely relative to the axial direction; and the first air guide surface and the second air guide surface of each axial flow blade have projections in the axial direction falling into the same two adjacent gaps, so that the first air guide surface of one axial flow blade and the second air guide surface of another adjacent axial flow blade cooperate to guide external gas into the two corresponding gaps in order.

3: The dual-profile strong-suction vortex fan blade of claim 2, wherein the first air guide surface and the second air guide surface are both curved structures recessed toward the centrifugal blades.

4: The dual-profile strong-suction vortex fan blade of claim 3, wherein each centrifugal blade includes a guide part and a blowing part;
the guide part and the blowing part are sequentially connected in a direction gradually away from the base, the guide part is convex in a rotating direction of the centrifugal blade, and the blowing part is convex in an opposite direction to the rotating direction of the centrifugal blade; and
ends of the first air guide surface and the second air guide surface away from the base both extend to a position adjacent to a joint of the guide part and the blowing part.

5: The dual-profile strong-suction vortex fan blade of claim 4, wherein a surface of the guide part directly facing the axial flow blades is a first side surface, the first air guide surface extends obliquely relative to the axial direction to a position adjacent to the first side surface of a first centrifugal blade, and the end of the first air guide surface away from the base extends to a position adjacent to a joint of the guide part and the blowing part of a second centrifugal blade;
wherein the first centrifugal blade and the second centrifugal blade are two adjacent centrifugal blades sequentially arranged in a rotating direction of the fan blades.

6: The dual-profile strong-suction vortex fan blade of claim 5, wherein the first side surface has a curved surface structure recessed in the axial direction, so that inner rings of all blowing parts form a circle of accommodation space in which the axial flow blades are received.

7: The dual-profile strong-suction vortex fan blade of claim 4, wherein the dual-profile strong-suction vortex fan blade further includes an outer ring connecting blowing parts of all the centrifugal blades.

8: A dual-profile strong-suction vortex fan blade, comprising a base, and a plurality of centrifugal blades and a plurality of axial flow blades respectively connected to the base, wherein
the plurality of centrifugal blades and the plurality of axial flow blades circumferentially surround an outer periphery of the base, respectively, and the plurality of axial flow blades are arranged at an air intake side of the plurality of centrifugal blades; a gap is formed between every two adjacent centrifugal blades; the number of centrifugal blades is 2N times the number of axial flow blades, so that the number of gaps is also 2N times the number of axial flow blades; and each axial flow blade extends obliquely relative to an axial direction and gradually approaches two adjacent gaps which are right opposite to the axial flow blade, so that each axial flow blade guides external gas into the two corresponding gaps in order, where N>1 and N is an integer.

9: The dual-profile strong-suction vortex fan blade of claim 8, wherein a surface of the axial flow blades facing the centrifugal blades is a first air guide surface; a surface of the axial flow blades facing away from the centrifugal blades is a second air guide surface; the first air guide surface and the second air guide surface of each axial flow blade both gradually approach the gap obliquely relative to the axial direction; and the first air guide surface and the second air guide surface of each axial flow blade have projections in the axial direction falling into the same two adjacent gaps, so that the first air guide surface of one axial flow blade and the second air guide surface of another adjacent axial flow blade cooperate to guide external gas into the two corresponding gaps in order.

10: The dual-profile strong-suction vortex fan blade of claim 9, wherein the first air guide surface and the second air guide surface are both curved structures recessed toward the centrifugal blades.

11: The dual-profile strong-suction vortex fan blade of claim 10, wherein each centrifugal blade includes a guide part and a blowing part;
the guide part and the blowing part are sequentially connected in a direction gradually away from the base, the guide part is convex in a rotating direction of the centrifugal blade, and the blowing part is convex in an opposite direction to the rotating direction of the centrifugal blade; and
ends of the first air guide surface and the second air guide surface away from the base both extend to a position adjacent to a joint of the guide part and the blowing part.

12: The dual-profile strong-suction vortex fan blade of claim 11, wherein a surface of the guide part directly facing the axial flow blades is a first side surface, the first air guide surface extends obliquely relative to the axial direction to a position adjacent to the first side surface of a first centrifugal blade, and the end of the first air guide surface away from the base extends to a position adjacent to a joint of the guide part and the blowing part of a second centrifugal blade;
wherein the first centrifugal blade and the second centrifugal blade are two adjacent centrifugal blades sequentially arranged in a rotating direction of the fan blades.

13: The dual-profile strong-suction vortex fan blade of claim 12, wherein the first side surface has a curved surface structure recessed in the axial direction, so that inner rings of all blowing parts form a circle of accommodation space in which the axial flow blades are received.

14: The dual-profile strong-suction vortex fan blade of claim 11, wherein he dual-profile strong-suction vortex fan blade further includes an outer ring connecting blowing parts of all the centrifugal blades.

15: A fan, in adopting a dual-profile strong-suction vortex fan blade, wherein the dual-profile strong-suction vortex fan blade comprises: a base, and a plurality of centrifugal blades and a plurality of axial flow blades respectively connected to the base, wherein
the plurality of centrifugal blades and the plurality of axial flow blades circumferentially surround an outer periphery of the base, respectively, and the plurality of axial flow blades are arranged at an air intake side of the plurality of centrifugal blades: a gap is formed between every two adjacent centrifugal blades: the number of centrifugal blades is twice the number of axial flow blades, so that the number of gaps is also twice the number of axial flow blades; and each axial flow blade extends obliquely relative to an axial direction and gradually approaches two adjacent gaps which are right opposite to the axial flow blade, so that each axial flow blade guides external gas into the two corresponding gaps in order.

16. (canceled)

17: The fan of claim 15, wherein a surface of the axial flow blades facing the centrifugal blades is a first air guide surface; a surface of the axial flow blades facing away from the centrifugal blades is a second air guide surface; the first air guide surface and the second air guide surface of each axial flow blade both gradually approach the gap obliquely relative to the axial direction; and the first air guide surface and the second air guide surface of each axial flow blade have projections in the axial direction falling into the same two adjacent gaps, so that the first air guide surface of one axial flow blade and the second air guide surface of another adjacent axial flow blade cooperate to guide external gas into the two corresponding gaps in order.

18: The fan of claim 17, wherein the first air guide surface and the second air guide surface are both curved structures recessed toward the centrifugal blades.

19: The fan of claim 18, wherein each centrifugal blade includes a guide part and a blowing part;
the guide part and the blowing part are sequentially connected in a direction gradually away from the base, the guide part is convex in a rotating direction of the centrifugal blade, and the blowing part is convex in an opposite direction to the rotating direction of the centrifugal blade; and
ends of the first air guide surface and the second air guide surface away from the base both extend to a position adjacent to a joint of the guide part and the blowing part.

20: A fan, adopting a dual-profile strong-suction vortex fan blade, wherein the dual-profile strong-suction vortex fan blade comprises: a base, and a plurality of centrifugal blades and a plurality of axial flow blades respectively connected to the base, wherein
the plurality of centrifugal blades and the plurality of axial flow blades circumferentially surround an outer periphery of the base, respectively, and the plurality of axial flow blades are arranged at an air intake side of the plurality of centrifugal blades; a gap is formed between every two adjacent centrifugal blades; the number of centrifugal blades is 2N times the number of axial flow blades, so that the number of gaps is also 2N times the number of axial flow blades; and each axial flow blade extends obliquely relative to an axial direction and gradually approaches two adjacent gaps which are right opposite to the axial flow blade, so that each axial flow blade guides external gas into the two corresponding gaps in order, where N&gt;1 and N is an integer.

21: The fan of claim 20, wherein a surface of the axial flow blades facing the centrifugal blades is a first air guide surface; a surface of the axial flow blades facing away from the centrifugal blades is a second air guide surface; the first air guide surface and the second air guide surface of each axial flow blade both gradually approach the gap obliquely relative to the axial direction; and the first air guide surface and the second air guide surface of each axial flow blade have projections in the axial direction falling into the same two adjacent gaps, so that the first air guide surface of one axial flow blade and the second air guide surface of another adjacent axial flow blade cooperate to guide external gas into the two corresponding gaps in order.
